(19) United States
(12) Patent Application Publication
(10) Pub. No.: US 2018/0292292 A1
(43) Pub. Date: Oct. 11, 2018

(54) PIPE CONDITION DETECTION DEVICE, PIPE CONDITION DETECTION METHOD, COMPUTER-READABLE RECORDING MEDIUM, AND PIPE CONDITION DETECTION SYSTEM

(71) Applicant: NEC Corporation, Minato-ku, Tokyo (JP)

(72) Inventors: Masatake TAKAHASHI, Tokyo (JP); Shin TOMINAGA, Tokyo (JP); Jun SAKAI, Tokyo (JP); Hirofumi INOUE, Tokyo (JP)

(73) Assignee: NEC Corporation, Minato-ku, Tokyo (JP)

(21) Appl. No.: 15/767,389

(22) PCT Filed: Nov. 1, 2016
(86) PCT No.: PCT/JP2016/082405

§ 371 Date: Apr. 11, 2018

(30) Foreign Application Priority Data
Nov. 4, 2015 (JP) 2015-216244

(51) Int. Cl. G01M 5/00; G01H 3/06; G01H 3/14; G01M 3/18

(52) U.S. Cl. CPC G01M 5/0058; G01H 3/06; F17D 5/00; G01M 5/0025; G01M 3/18; G01H 3/14

(57) ABSTRACT

There are circumstances in which estimation of a pipe condition is desired as needs of water utility companies, and thus, an object of the present invention is to provide a technique that can estimate conditions of deterioration or a defect inside and outside a pipe.

In order to solve the problem, a pipe condition detection system according to the present invention includes: a sensor unit that detects vibration data and pressure data from a pipe or fluid in the pipe; and a determination unit that determines conditions inside and outside the pipe, based on the vibration data and the pressure data acquired by the sensor unit.

### TECHNICAL FIELD

The present invention relates to a pipe condition detection device, a pipe condition detection method, a computer-readable recording medium, and a pipe condition detection system.

### BACKGROUND ART

Due to progress in IT and network technology supported by digitalization, an information amount handled and accumulated by persons and electronic devices is steadily increasing. In order for human society getting distracted with a large amount of information to establish safe and secure society, it is regarded as important that accurate data of an event are acquired from a sensor as an input device, accurately analyzed, determined, and processed, and are recognized as useful information by a person.

Facilities such as water supply and sewer networks and high pressure chemical pipelines for gas, oil, and the like are constructed, and function as foundations for affluent society. As inspection of fluid leakage due to deterioration and destruction of pipes such as water supply and sewer networks and pipelines, an auditory-sensing test in which a person listens to leaking sounds is generally performed. However, leakage inspection by audition is posterior maintenance activity, and thus requires prompt action such as repair and replacement after detection. In order to solve such a problem, a method of inspection by a machine has been proposed.

### CITATION LIST

### Patent Literature

[PTL 1] Japanese Laid-open Patent Publication No. 2013-61350

[PTL 2] Japanese Laid-open Patent Publication No. 2004-28976

[PTL 3] Japanese Laid-open Patent Publication No. 2002-236115

[PTL 4] Japanese Laid-open Patent Publication No. H06-342444

### SUMMARY OF INVENTION

### Technical Problem

PTL 1 discloses a technique of applying vibration by a vibrator installed at a conduit buried in the ground, detecting the vibration by vibration sensors installed at two positions on the conduit and thereby measuring a vibration propagation speed in the conduit, estimating a thickness of a conduit wall from a theoretical formula, and diagnosing a deterioration condition. The deterioration diagnosis method according to the technique of PTL 1 estimates an inner diameter and a thickness of a pipe, but does not estimate conditions inside and outside a pipe.

There are circumstances in which estimation of a pipe condition is desired as needs of water utility companies. Thus, an object of the present invention is to provide a technique that can estimate conditions of deterioration or a defect inside and outside a pipe.

### Solution to Problem

A pipe condition detection system according to the present invention includes: a sensor unit that detects vibration data and pressure data from a pipe or fluid in the pipe; and a determination unit that determines conditions inside and outside the pipe, based on the vibration data and the pressure data acquired by the sensor unit.

A pipe condition detection method according to the present invention includes: acquiring vibration data and pressure data acquired by a sensor unit; and determining conditions inside and outside a pipe, based on the acquired vibration data and pressure data.

A pipe condition detection program according to the present invention causes a computer to execute: a process of acquiring vibration data and pressure data acquired by a sensor unit; and a process of determining conditions inside and outside the pipe, based on the acquired vibration data and pressure data.

### Advantageous Effects of Invention

According to the present invention, conditions of deterioration or a defect inside and outside a pipe can be estimated.

### BRIEF DESCRIPTION OF DRAWINGS

FIG. 1 is a block diagram illustrating functional blocks of a pipe condition detection system according to a first example embodiment.

FIG. 2 is a diagram illustrating a hardware configuration of a pipe condition detection system according to the first example embodiment.

FIG. 3 is a flowchart illustrating a flow from data collection to data transmission by a sensor unit in the first example embodiment.

FIG. 4 is a flowchart illustrating a flow of pipe condition detection by a pipe condition detection device in the first example embodiment.

FIG. 5 is a diagram illustrating a relation between an inner diameter and a frequency in the first example embodiment.

FIG. 6 is a diagram illustrating a relation between a pipe wall parameter of a pipe and a frequency in the first example embodiment.

FIG. 7 is a diagram illustrating examples of a pipe condition detected by the pipe condition detection device according to the first example embodiment.

FIG. 8 is a block diagram illustrating functional blocks of a pipe condition detection system according to a second example embodiment.

FIG. 9 is a flowchart illustrating a flow from data collection to data transmission by a sensor unit in the second example embodiment.

FIG. 10 is a flowchart illustrating a flow of pipe condition detection by a pipe condition detection device in the second example embodiment.

### DESCRIPTION OF EMBODIMENTS

### First Example Embodiment

Hereinafter, an example embodiment of the present invention is described with reference to the drawings. The example embodiment of the present invention is described by citing, as an example, a system for detecting a pipe condition of a water pipe by using a vibration sensor and a pressure sensor installed at the water pipe. Note that the present invention is not limited to waterworks, but can be applied to a pipe for carrying gas, air, or the like. Here, the “pipe condition” in the present example embodiment represents a condition in which a pipe becomes thin by being worn out, for example. The “pipe condition” is not limited to the condition mentioned on the left, and may be a condition in which deposits accumulate on an inner wall of a pipe and an inner diameter of the pipe is thereby reduced, a condition in which an outer wall of a pipe is worn out due to corrosion or the like, a condition in which deposits adhere to an outer wall of a pipe and the pipe becomes thick, a condition in which these occur in a combined manner, or the like.

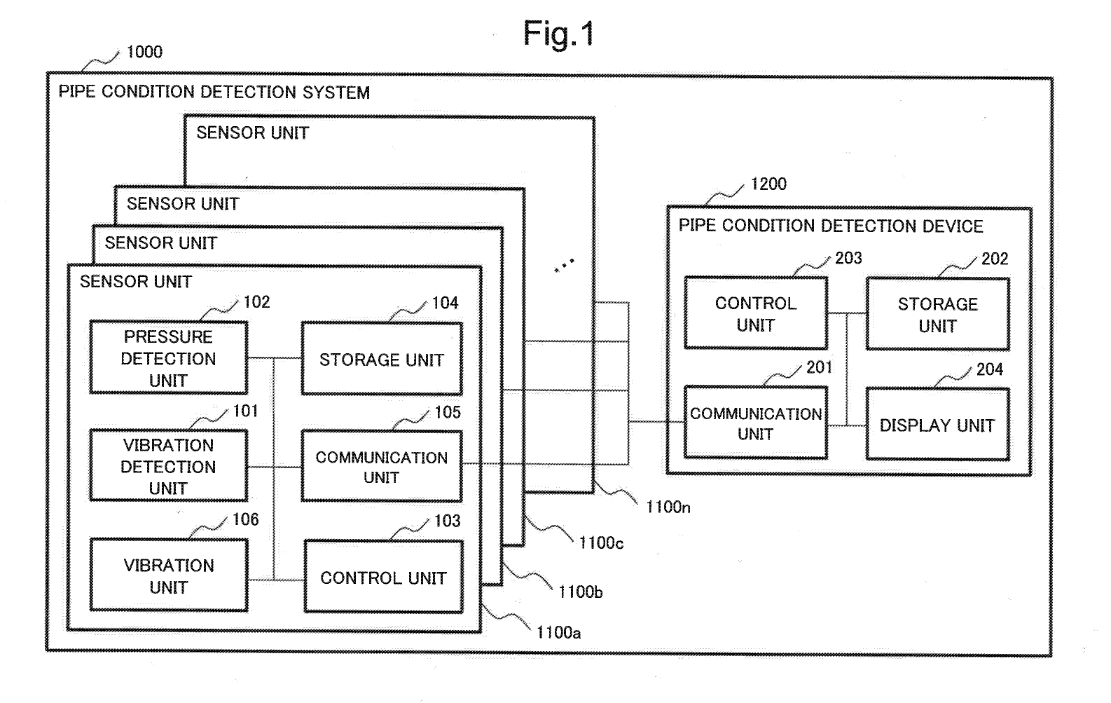

A configuration of the first example embodiment is described with reference to FIG. 1. FIG. 1 is a diagram illustrating a configuration of a pipe condition detection system 1000 according to the first example embodiment.

The pipe condition detection system 1000 includes a plurality of sensor units 1100a to 1100n and a pipe condition detection device 1200.

The sensor unit 1100 includes a vibration detection unit 101, a pressure detection unit 102, a control unit 103, a storage unit 104, a communication unit 105, and a vibration unit 106. The sensor unit 1100 is installed on a sprinkler head of a pipe. Note that the sensor unit 1100 may be installed on an outer wall surface of the pipe, an inner wall surface of the pipe, a stop cock, a pressure damping valve, a pressure control valve, a jig connected thereto, or the like. Although it is presupposed that a plurality of the sensor units 1100 exist in the present example embodiment, the number of the sensor units 110 is not limited to the example illustrated in FIG. 1, and the number of the sensor units 1100 may be one. A plurality of the sensor units 1100a to 1100n may be installed at pipe different networks from each other. A distance between a plurality of the sensor units 1100a to 1100n may be set at a certain distance. While the sensor unit 1100 has an advantage of easily picking up vibrations when the sensor unit 1100 can be installed directly on a pipe wall of the pipe, there is a problem that installation thereof is difficult when the pipe is buried in the ground. When the sensor unit 1100 is installed at a sprinkler head or a stop cock, application and installation thereof can be made even without direct access to a pipe wall, and thus, installation cost of the sensor unit 1100 can be reduced.

The vibration detection unit 101 detects vibrations propagating through the pipe or fluid inside the pipe. The vibration detection unit 101 is configured so as to include a signal reception unit (not illustrated) and a signal conversion unit (not illustrated). The signal reception unit receives data of the vibrations. The signal conversion unit converts the vibration data from an analog signal into a digital signal. Hereinafter, conversion from an analog signal into a digital signal is called A/D (analog-to-digital) conversion. The vibration detection unit 101 stores, in the storage unit 104, as a detection signal, an electric signal according to an amplitude and a frequency of the detected vibrations.

The pressure detection unit 102 detects a pressure of fluid inside the pipe. The pressure detection unit 102 is configured so as to include a signal reception unit (not illustrated) and a signal conversion unit (not illustrated). The signal reception unit receives data of the pressure. The signal conversion unit A/D-converts the pressure data from an analog signal into a digital signal. The pressure detection unit 102 stores, in the storage unit 104, as a detection signal, an electric signal in accordance with magnitude of the detected pressure.

The control unit 103 controls the vibration detection unit 101, the pressure detection unit 102, the communication unit 105, and the vibration unit 106. Specifically, the control unit 103 controls a control period (control time), a control start timing, a control end timing, and the like of the vibration detection unit 101 and the pressure detection unit 102. Further, the control unit 103 controls a vibration timing of the vibration unit 106.

The storage unit 104 stores the digitized vibration data, the pressure data, and signal-processed data, and various programs, control period of the sensors, a control start timing of the sensors, a control end timing of the sensors, a vibration timing that is a timing at which the vibration unit 106 starts to vibrate, and the like. The storage unit 104 stores vibration data in a specific period (for example, one day, one hour, or the like) or signal-processed data of the vibration data, and pressure data or signal-processed data of the pressure data. The specific period is not limited to one day or one hour. The storage unit 104 is a hard disk. The storage unit 104 may be a volatile memory or a nonvolatile memory.

The communication unit 105 transmits vibration data and pressure data stored in the storage unit 104 to the pipe condition detection device 1200 via a communication network. The communication network is not particularly limited, and can be a known communication network. Specifically, for example, an Internet line, a telephone line, a LAN (Local Area Network), and the like can be cited. It may be wireless or wired.

The vibration unit 106 excites vibrations directly or indirectly to the pipe. Specifically, the vibrating unit 106 includes a remote-operation type sensor (not illustrated) driven by a battery. The remote-operation type sensor is activated by an instruction from the control unit 103 provided in the sensor unit 1100. The remote-operation type sensor includes a built-in vibrator (not illustrated). The remote-operation type sensor excites vibrations to a target workpiece by using the built-in vibrator. Here, the vibrating unit 106 is configured so as to electrically generate vibrations, but may be configured so as to mechanically generate vibrations in the pipe. The vibration unit 106 is configured so as to be included in the sensor unit 1100 in the present example embodiment, but does not particularly need to be integrally configured. Specifically, the vibration unit 106 and the sensor unit 1100 may be configured so as to be arranged at separate fire hydrants, respectively. By arranging the vibration unit 106 and the sensor unit 1100 at such a distance that no signal saturation occurs, the sensor unit 1100 can more accurately acquire vibration data and pressure data. Further, the vibration unit 106 may be a valve (not illustrated) or a pump (not illustrated) for controlling a flow rate of the pipe. When the vibration unit 106 is a valve (not illustrated) or a pump for controlling a flow rate of the pipe, controlling the valve or the pump may generate a water impact. The generated water impact becomes a waveform propagating through the pipe. The waveform mentioned on the left is measured as a pressure by the sensor unit 1100.

The pipe condition detection device 1200 includes a communication unit 201, a storage unit 202, a control unit 203, and a display unit 204. The pipe condition detection device 1200 is installed in a monitoring room in a water utility company, for example. Note that the pipe condition detection device 1200 may be a server or a portable device such as a mobile phone and a tablet.

The communication unit 201 receives, via the communication network, vibration data acquired by each of the sensor units 1100a to 1100n. Further, the communication unit 201 may be configured so as to transmit current time or the like to the sensor unit 1100a. The communication network is not particularly limited, and can be a known communication network. Specifically, for example, an Internet line, a telephone line, a LAN (Local Area Network), or the like can be cited. Those may be wireless or wired.

The storage unit 202 stores vibration data and pressure data acquired by the communication unit 201 from the sensor units 1100a to 1100n, various programs, and the like. The storage unit 202 is a hard disk. The storage unit 202 may be a volatile memory or a nonvolatile memory.

The control unit 203 acquires vibration data and pressure data from the storage unit 202. The control unit 203 stores the acquired vibration data in the storage unit 202. Further, the control unit 203 determines abnormality of the pipe, based on the acquired vibration data and pressure data. A detailed method for detecting abnormality in the pipe is described later. In addition, the control unit 203 displays, via the display unit 204, a determination result such as presence or absence of abnormality in the pipe and an abnormality type of the pipe. The control unit 203 may be configured so as to acquire vibration data and pressure data directly from the communication unit 201.

The display unit 204 displays the determination result of a deterioration condition of the pipe. The display unit 204 is configured so as to include a liquid crystal display.

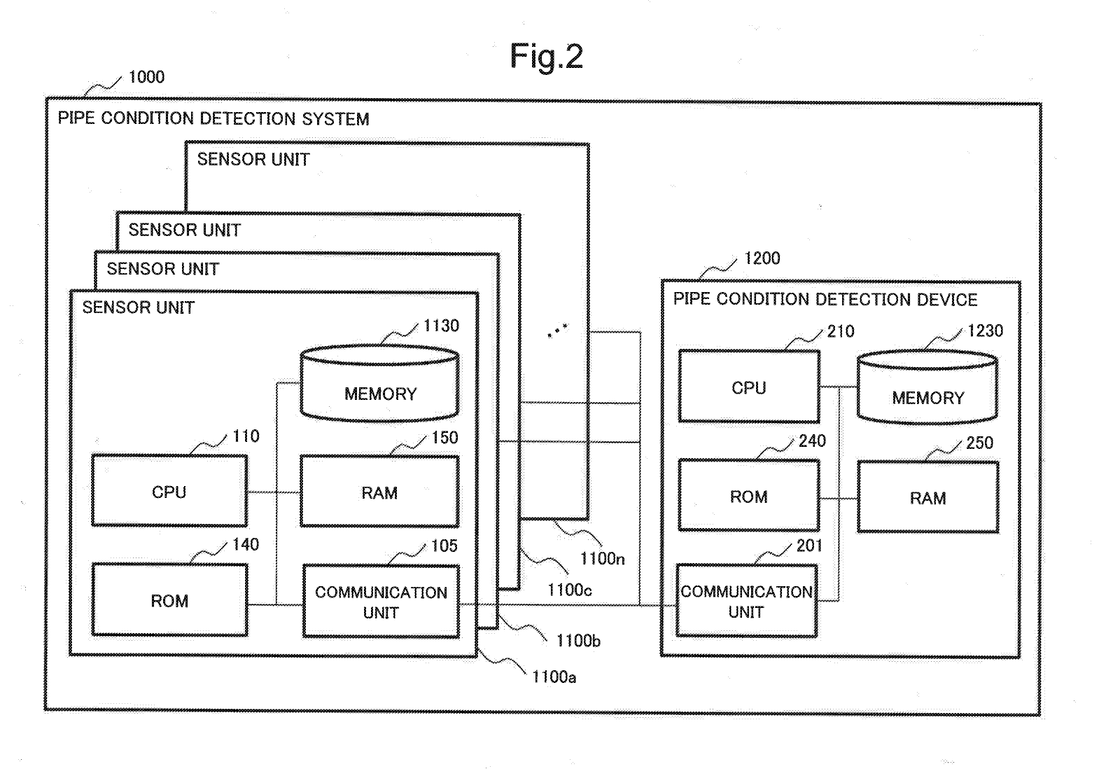

FIG. 2 is a block diagram illustrating a hardware configuration of the pipe condition detection system 1000 according to the first example embodiment.

The sensor unit 1100a includes a CPU (Central Processing Unit) 110, a memory 1130 as the storage unit 104, a communication unit 105, a ROM (Read Only Memory) 140, and a RAM (Random Access Memory) 150. The memory 1130, the communication unit 105, the ROM 140, and the RAM 150 are connected to the CPU 110. Further, the CPU 110 implements the functional blocks illustrated in FIG. 1 by executing a program stored in the memory 1130, depending on necessity.

The pipe condition detection device 1200 includes a CPU (Central Processing Unit) 210, a memory 1230 as the storage unit 202, a communication unit 201, a ROM (Read Only Memory) 240, and a RAM (Random Access Memory) 250. The memory 1230, the communication unit 201, the ROM 240, and the RAM 250 are connected to the CPU 210. The CPU 210 implements the functional blocks illustrated in FIG. 1 by executing a program stored in the memory 1230, depending on necessity.

### Data Collection Method

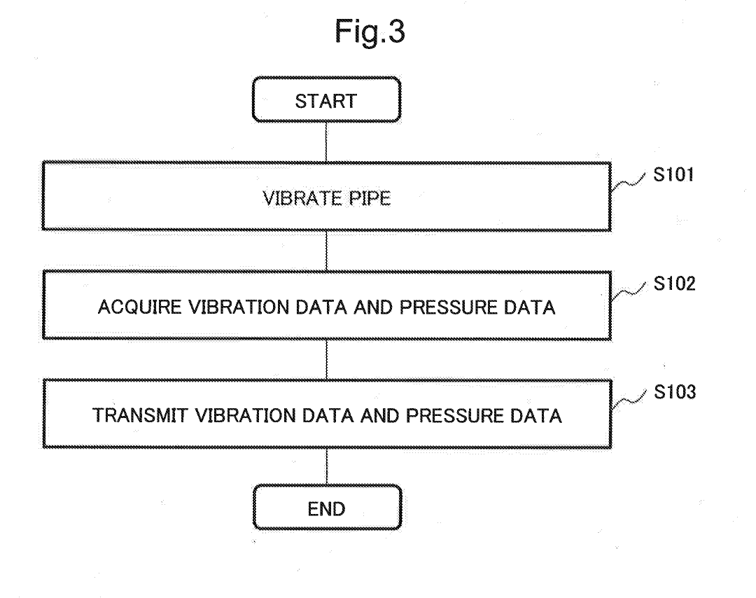

The data acquisition method of the sensor unit 1100 is described with reference to FIG. 3. FIG. 3 is a flowchart illustrating a data acquisition flow of the sensor unit 1100.

At the step S101, the control unit 103 vibrates the vibration unit 106, based on a vibration timing stored in the storage unit 104, and the flow proceeds to the step S102.

At the step S102, the control unit 103 causes the vibration detection unit 101 to collect vibration data. Further, the control unit 103 causes the pressure detection unit 102 to collect the pressure data. The vibration detection unit 101 A/D-converts the acquired vibration data. The pressure detection unit 102 A/D-converts the acquired pressure data. The control unit 103 causes the vibration detection unit 101 and the pressure detection unit 102 to store the A/D-converted data in the storage unit 104, and the flow proceeds to the step S103.

At the step S103, the control unit 103 transmits the A/D-converted vibration data and the A/D-converted pressure data to the pipe condition detection device 1200 via the communication unit 105, and the flow is ended.

### Pipe Condition Detection Method

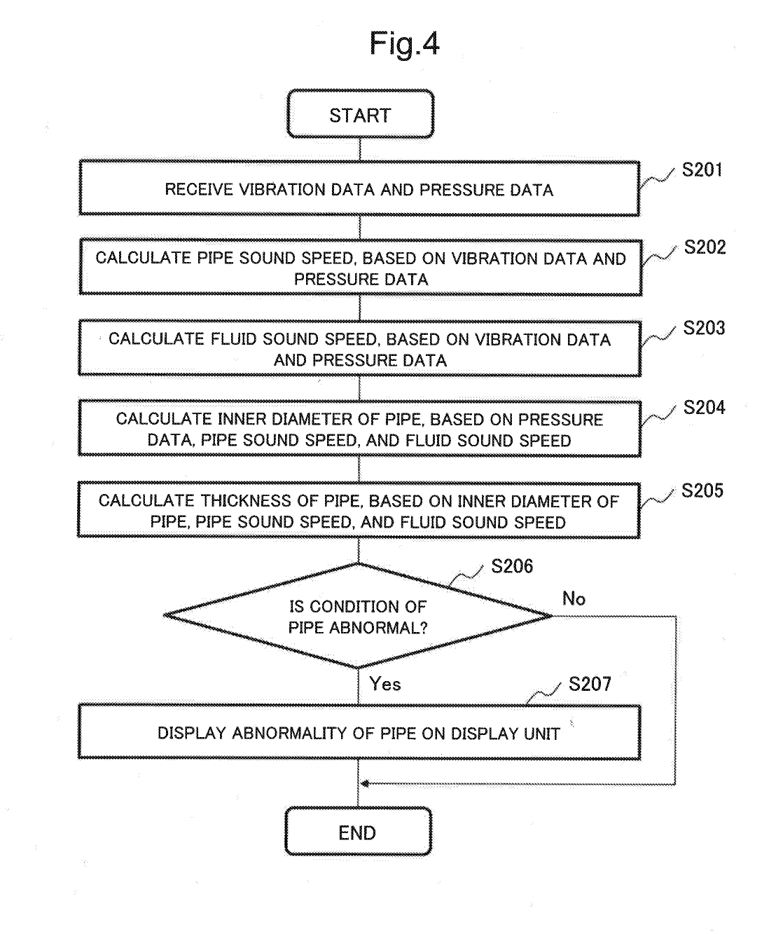

The pipe condition detection method according to the pipe condition detection device 1200 is described with reference to FIG. 4. FIG. 4 is a flowchart illustrating a flow of the pipe condition detection method of the pipe condition detection device 1200.

At the step S201, the communication unit 201 receives vibration data and pressure data from each sensor unit 1100. The control unit 203 stores the received vibration data and pressure data in the storage unit 202, and the flow proceeds to the step S202.

At the step S202, the control unit 203 acquires vibration data and pressure data of each sensor unit 1100 stored in the storage unit 202. Here, the control unit 203 may be configured so as to acquire the vibration data received by the communication unit 201. The control unit 203 calculates a pipe sound speed that is a sound speed of a wave propagating through the pipe, by using the acquired vibration data and pressure data, and the flow proceeds to the step S303. The pipe sound speed is calculated based on a difference between time points at which a vibration generated at a specific spot reaches the respective sensor units 1100, and a distance between the sensor units 1100, for example.

At the step S203, by using the acquired pressure data and the like, the control unit 203 acquires a fluid sound speed that is a sound speed of a wave propagating through fluid flowing in the pipe, and the flow proceeds to the step S204. Here, the sound speed of the fluid is acquired by using a value (literature value) acquired in advance in accordance with a pressure indicated by the acquired pressure data, for example. Presence or absence of bubbles included in the fluid, and a composition of the fluid may be taken into account for the literature value.

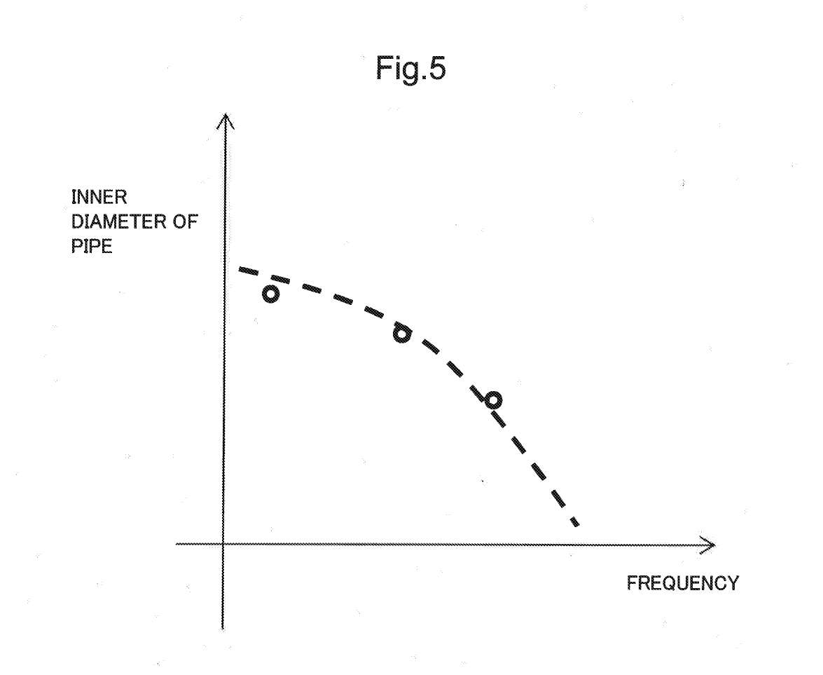

At the step S204, based on the formula (1), the control unit 203 calculates an inner diameter a of the pipe by using the acquired pressure data, the calculated pipe sound speed, and the calculated fluid sound speed, and the flow proceeds to the step S205. Here, in the formula (1), a is an inner diameter of the pipe, W is a vibration displacement, P is a pressure, Bf is a bulk modulus of the fluid, Cs is a pipe sound speed, and Cf is a fluid sound speed. The vibration displacement W is calculated from vibration data collected by the sensor units 1100. The pressure P is calculated from pressure data collected by the sensor units 1100. The pipe sound speed Cs and the fluid sound speed Cf are calculated by the control unit 203. The formula (1) can be calculated by using a literature value for the bulk modulus Bf of the fluid. Here, since the vibration displacement W, the pressure P, and the pipe sound speed Cs depend on a frequency, the calculated inner diameter a of the pipe represents an effective inner diameter. A value at a specific frequency may be calculated as the inner diameter a of the pipe, but values at a plurality of frequencies, for example, at three or more points are desirably calculated. A method for calculating the inner diameter a of the pipe is not limited to the above-described calculation method. Specifically, a configuration may be made such that the inner diameter a of the pipe is calculated from a diagram representing a relation between the inner diameter a of the pipe and the frequency f illustrated in FIG. 5. Note that FIG. 5 illustrates an approximate curve acquired based on a relation between the inner diameter a of the pipe and the frequency f acquired by an experiment or the like.

$$a ( f ) = \frac{W}{P} \frac{2 {B}_{f}}{[ {( \frac{{C}_{f}}{{C}_{s} ( f )} )}^{2} - 1 ]} \qquad ( 1 )$$

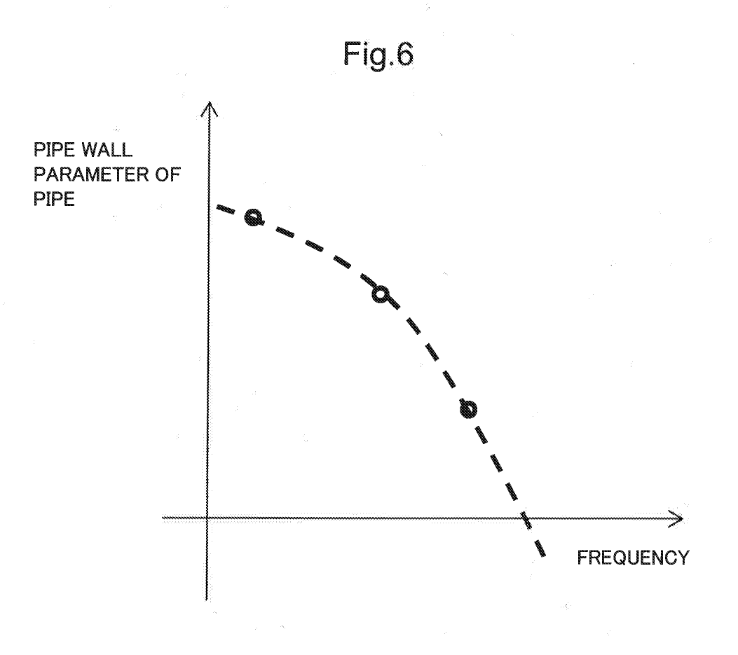

At the step S205, based on the formula (2), the control unit 203 calculates a pipe wall parameter of the pipe by using the calculated inner diameter a of the pipe, the calculated pipe sound speed, and the calculated fluid sound speed, and the flow proceeds to the step S206. The pipe wall parameter is an index indicating a mechanical condition related to hardness of the pipe wall. The symbol G indicates a relation between the pipe wall parameter and other elements related to the pipe. Here, in the formula (2), E is a Young's modulus, and ρ is a density of a pipe material. A bulk modulus of the fluid Bf, a fluid sound speed Cf, and a pipe sound speed Cs are known from the above description. For the Young's modulus E and the density ρ of the pipe material, literatures can be referred to, or values of an experiment using a pipe whose condition has been changed by being buried over years or has been forcibly changed by an experiment can be used. Based on the formula (2), a thickness h of the pipe material that is the pipe wall parameter of the pipe can be acquired. When the Young's modulus is unknown, the pipe wall parameter of the pipe may be a product of the Young's modulus E and the thickness h of the pipe material. Here, when the density ρ of the pipe material is unknown, the pipe wall parameter of the pipe may be a product of the density ρ of the pipe material and the thickness h of the pipe material. The method of calculating the pipe wall parameter of the pipe is not limited to the above-described calculation method. Specifically, a configuration may be made such that the pipe wall parameter of the pipe is calculated from a diagram representing a relation between the pipe wall parameter of the pipe and the frequency f illustrated in FIG. 6. Note that FIG. 6 illustrates an approximate curve acquired based on a relation between the pipe wall parameter of the pipe and the frequency f acquired by an experiment or the like.

$$G = h ( \frac{E}{{a ( f )}^{2}} - {( 2 π f )}^{2} ρ ) - \frac{2 {B}_{f} a ( f )}{[ {( \frac{{C}_{f}}{{C}_{s} ( f )} )}^{2} - 1 ]} \qquad ( 2 )$$

At the step S206, the control unit 203 determines a condition of the pipe, based on the inner diameter a of the pipe and the thickness of the pipe as one of the pipe wall parameters of the pipe calculated at the step S204 and the step S205. Specifically, the control unit 203 compares an initial value of the inner diameter of the pipe stored in the storage unit 202, with the inner diameter a of the pipe calculated this time. When an absolute value of a difference between the initial value of the inner diameter of the pipe and the inner diameter a of the pipe calculated this time is smaller than a first predetermined value, the control unit 203 determines that an inside of the pipe is normal. On the contrary, when an absolute value of a difference between the initial value of the inner diameter of the pipe and the inner diameter a of the pipe calculated this time is equal to or larger than the first predetermined value, the control unit 203 determines that an inside of the pipe is abnormal. Further, when the inner diameter a of the pipe calculated this time is larger than the initial value of the inner diameter of the pipe, the control unit 203 determines that the pipe has been worn out due to aged deterioration. Meanwhile, when the inner diameter a of the pipe calculated this time is smaller than the initial value of the inner diameter of the pipe, the control unit 203 determines that foreign substances or the like in the fluid have accumulated inside the pipe, since the inner diameter of the pipe has been reduced. When an absolute value of a difference between an initial value of the pipe wall parameter of the pipe and the pipe wall parameter of the pipe calculated this time is smaller than a second predetermined value, the control unit 203 determines that an outside of the pipe is normal. When an absolute value of a difference between the initial value of the pipe wall parameter of the pipe and the pipe wall parameter of the pipe calculated this time is equal to or larger than the second predetermined value, and the pipe wall parameter of the pipe calculated this time is larger than the initial value of the pipe wall parameter of the pipe, the control unit 203 determines that deposits have accumulated in the pipe and the rigidity of the pipe has become high, and determines that an outside of the pipe is normal. When an absolute value of a difference between the initial value of the pipe wall parameter of the pipe and the pipe wall parameter of the pipe calculated this time is equal to or larger than the second predetermined value, and the pipe wall parameter of the pipe calculated this time is smaller than the initial value of the pipe wall parameter of the pipe, the control unit 203 determines that the rigidity of the pipe has decreased since a specific constituent of the pipe has escaped into the fluid or the pipe has corroded, and determines that an outside of the pipe is abnormal. Thus, based on the inner diameter a of the pipe and the pipe wall parameter of the pipe, the control unit 203 determines pipe conditions (deterioration or a defect) inside and outside the pipe. Here, a configuration is made in the above such that the determination method by the control unit 203 makes determination by comparing values. However, without limitation to the above-described configuration, it is possible to adopt a method of determining deterioration conditions inside and outside the pipe by comparing values of the calculated inner diameter a of the pipe and the calculated pipe wall parameter, with a two-dimensional map whose horizontal axis represents the inner diameter of the pipe stored in the storage unit 203 and whose vertical axis represents the pipe wall parameter. Note that in the above description, conditions inside and outside the pipe mainly indicate respective conditions of an inner wall and an outer wall of the pipe.

At the step S207, the control unit 203 causes the display unit 204 to display presence or absence of abnormality inside and outside of the pipe, and a pipe condition, and ends the flow. As specific messages of the pipe condition, there are messages such as “the inner diameter of the pipe has expanded due to wear” and “the rigidity of the pipe has decreased”. The display unit 204 may be configured to output an alarm such as a sound and a vibration, depending on the condition.

### OPERATION EXAMPLE

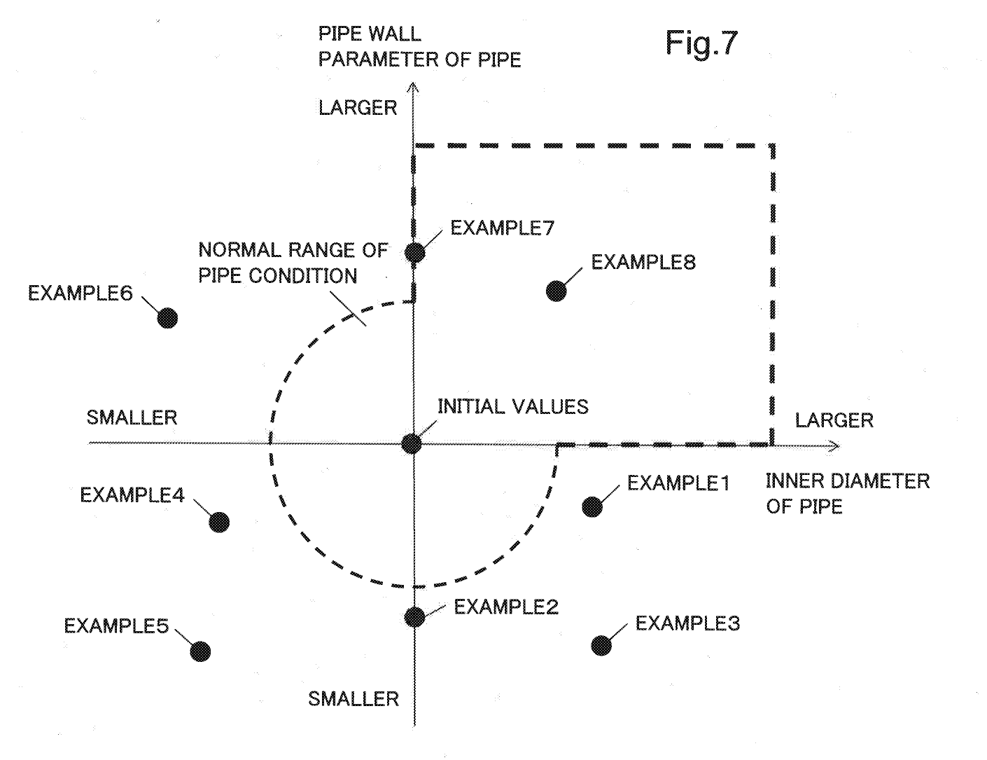

An example in which the first example embodiment is applied is described with reference to FIG. 7. FIG. 7 is a diagram illustrating, as an example, a pipe condition detected by the pipe condition detection device. In FIG. 7, the vertical axis represents a pipe wall parameter of the pipe, and the horizontal axis represents an inner diameter of the pipe. The dot located at the center of the drawing indicates an initial value. The dotted line in FIG. 7 indicates a normal range as an example. The normal range is not particularly limited, and may be appropriately set by a user. When a calculated inner diameter of the pipe and a calculated pipe wall parameter of the pipe are within the normal range, the control unit 203 determines that the pipe condition is normal. Specific determination results are exemplified below.

In the case of the example 1, the control unit 203 determines that a condition of the pipe is abnormal because of deviation from the normal range. Further, since the inner diameter of the pipe increases from the initial value, and a value of the pipe wall parameter decreases from the initial value, the control unit 203 causes the display unit 204 to display, as a message, that a pipe thickness has decreased due to wear of the pipe. In addition, the control unit 203 determines that an inside of the pipe is abnormal and an outside of the pipe is normal. Based on the determination result of the control unit 203, the display unit 204 displays that the inside of the pipe is abnormal.

In the case of the example 2, the control unit 203 determines abnormality because of deviation from the normal range. Since an inner diameter of the pipe does not change from the initial value, and a pipe wall parameter of the pipe decreases from the initial value, the control unit 203 causes the display unit 204 to display, as a message, that a constituent of the pipe escapes into the fluid. In addition, the control unit 203 determines that an inside of the pipe and an outside of the pipe are abnormal. Based on the determination result of the control unit 203, the display unit 204 displays that the inside of the pipe and the outside of the pipe are abnormal.

In the case of the example 3, the control unit 203 determines abnormality because of deviation from the normal range. Further, since an inner diameter of the pipe increases from the initial value, and a pipe wall parameter decreases compared with that of the example 1, the control unit 203 causes the display unit 204 to display, as a message, that a pipe thickness is reduced due to wear of the pipe and corrosion additionally occurs. In addition, the control unit 203 determines that an inside of the pipe is normal and an outside of the pipe is abnormal. Based on the determination result of the control unit 203, the display unit 204 displays that the outside of the pipe is abnormal.

In the case of the example 4, the control unit 203 determines abnormality since deviation from the normal range. Further, since an inner diameter of the pipe decreases from the initial value, and the pipe wall parameter also decreases from the initial value, the control unit 203 causes the display unit 204 to display, as a message, that deposits accumulate inside the pipe, and corrosion or escape of a constituent of the pipe into the fluid additionally occurs. In addition, the control unit 203 determines that an inside of the pipe and an outside of the pipe are abnormal. Based on the determination result of the control unit 203, the display unit 204 displays that the inside of the pipe and the outside of the pipe are abnormal.

In the case of the example 5, the control unit 203 determines abnormality because of deviation from the normal range. Further, since an inner diameter of the pipe decreases from the initial value and a pipe wall parameter decreases compared with that of the example 4, the control unit 203 causes the display unit 204 to display, as a message, that deposits accumulate inside the pipe, corrosion additionally occurs, and a constituent of the pipe escapes into the fluid. In addition, the control unit 203 determines that an inside of the pipe and an outside of the pipe are abnormal. Based on the determination result of the control unit 203, the display unit 204 displays that the inside of the pipe and the outside of the pipe are abnormal.

In the case of the example 6, the control unit 203 determines abnormality because of deviation from the normal range. Further, since an inner diameter of the pipe decreases from the initial value, and a value of the pipe wall parameter increases from the initial value, the control unit 203 causes the display unit 204 to display, as a message, that deposits accumulate inside the pipe. In addition, the control unit 203 determines that an inside of the pipe is abnormal and an outside of the pipe is normal. Based on the determination result of the control unit 203, the display unit 204 displays that the inside of the pipe is abnormal.

In the case of the example 7, the control unit 203 determines normality because of no deviation from the normal range. Further, since an inner diameter of the pipe does not change from the initial value, and a pipe wall parameter increases from the initial value, the control unit 203 causes the display unit 204 to display, as a message, that a constituent of the pipe has changed and the rigidity of the pipe thereby increased. In addition, the control unit 203 determines that an inside of the pipe and an outside of the pipe are normal.

In the case of the example 8, the control unit 203 determines normality because of no deviation from the normal range. Further, since an inner diameter of the pipe increases from the initial value, and a pipe wall parameter increases from the initial value, the control unit 203 causes the display unit 204 to display, as a message, that a pipe thickness is reduced due to wear of the pipe, and a constituent of the pipe has changed and the rigidity of the pipe thereby increased. In addition, the control unit 203 determines that an inside of the pipe and an outside of the pipe are normal. Herein, the control unit 203 is configured so as not to display normality on the display unit 204 in the present example, but may be configured so as to display normality even in a normal condition.

### Operation and Effect]

In the present invention, a configuration is made such that an inner diameter of a pipe and a pipe wall parameter of the pipe are calculated, and by combining them, a condition of the pipe is determined, and thus, a condition of deterioration of the pipe can be recognized in more detail.

### Second Example Embodiment

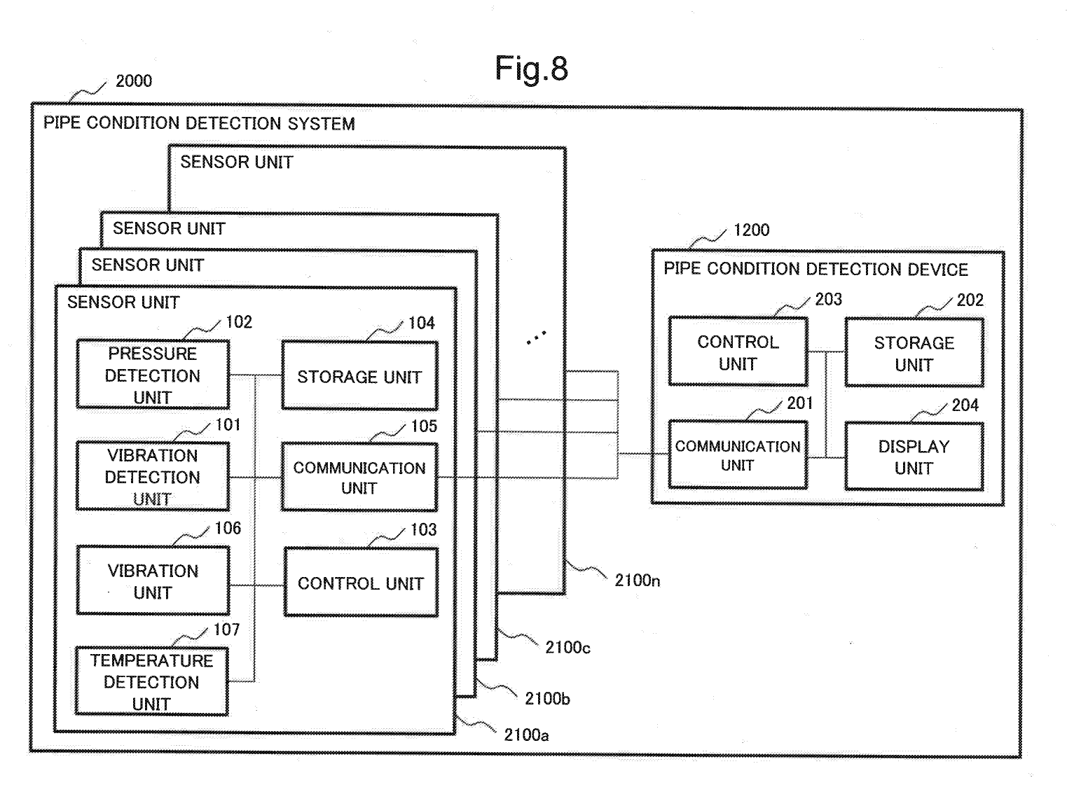

A configuration of a second example embodiment is described with reference to FIG. 8. FIG. 8 is a diagram illustrating the configuration of a pipe condition detection system 2000 according to the second example embodiment.

The pipe condition detection system 2000 includes a plurality of sensor units 2100a to 2100n and a pipe condition detection device 1200.

The sensor unit 2100 includes a vibration detection unit 101, a pressure detection unit 102, a control unit 103, a storage unit 104, a communication unit 105, a vibration unit 106, and a temperature detection unit 107. The sensor unit 2100 is installed at a sprinkler head of a pipe. Note that the sensor unit 2100 differs from the sensor unit 1100 according to the first example embodiment only in including the temperature detection unit 107, and thus, the descriptions other than the temperature detection unit 107 are omitted.

The temperature detection unit 107 detects a temperature of a pipe material. The temperature detection unit 107 is configured so as to include a signal reception unit (not illustrated) and a signal conversion unit (not illustrated). The signal reception unit receives data of the temperature. The signal conversion unit converts the temperature data from an analog signal into a digital signal. The temperature detection unit 107 stores the detected temperature of vibration, as a detection signal, in the storage unit 104.

### [Data Collection Method]

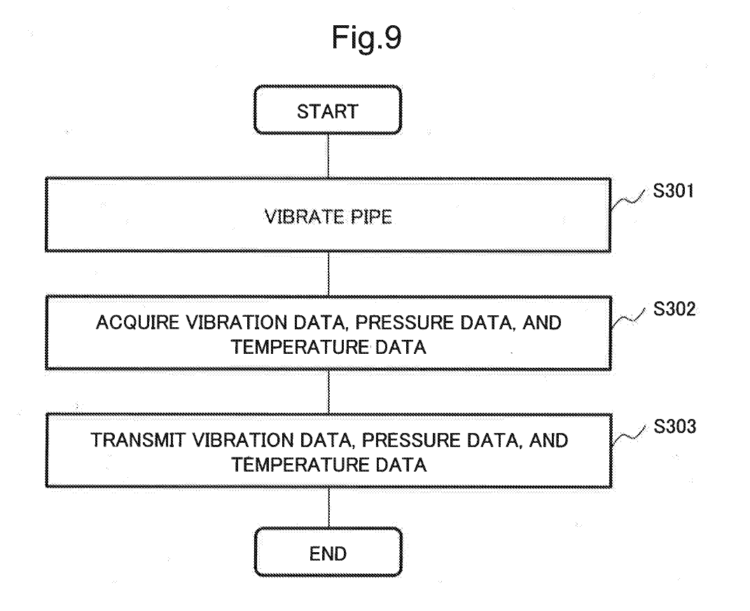

A data acquisition method of the sensor unit 2100 is described with reference to FIG. 9. FIG. 9 is a flowchart illustrating a data acquisition flow of the sensor unit 2100.

At the step S301, the processing similar to the step S101 in the first example embodiment is performed, and the flow proceeds to the step S302.

At the step S302, the control unit 103 causes the vibration detection unit 101 to collect vibration data. Further, the control unit 103 causes the pressure detection unit 102 to collect pressure data. In addition, the control unit 103 causes the temperature detection unit 107 to collect temperature data. The temperature detection unit 107 A/D-converts the acquired temperature data. The control unit 103 transmits the vibration data, the pressure data, and the temperature data to the pipe condition detection device 1200 via the communication unit 105, and the flow is ended.

### [Pipe Condition Detection Method]

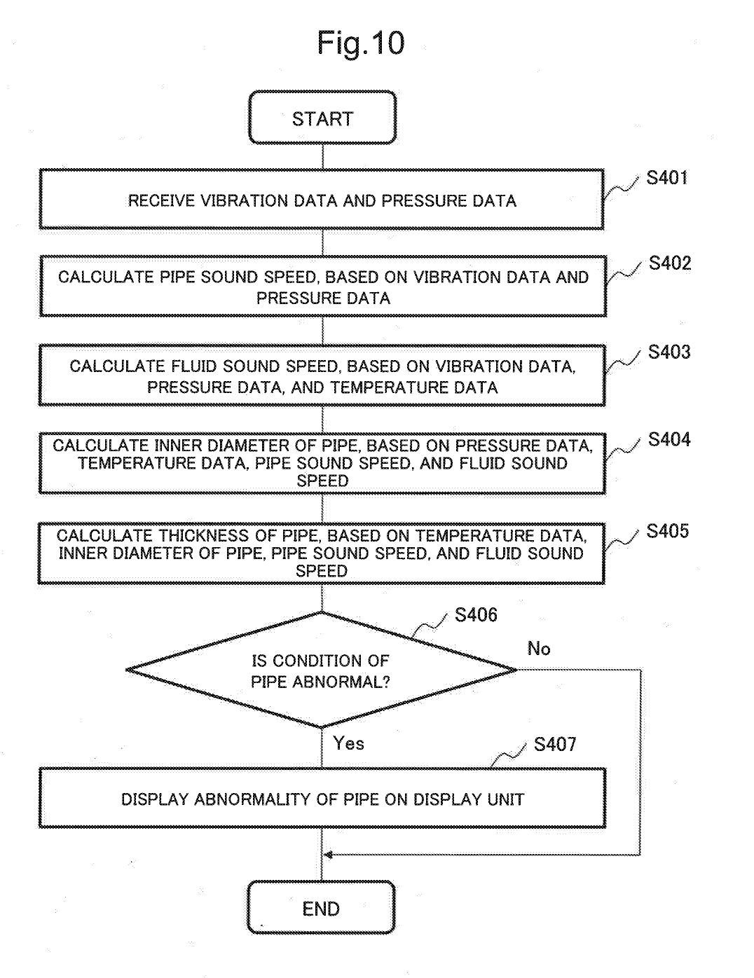

A pipe condition detection method according to the second example embodiment is described with reference to FIG. 10. FIG. 10 is a flowchart illustrating a flow of a deterioration detection method according to the second example embodiment.

At the step S401, the processing similar to the step S201 in the first example embodiment is performed. The control unit 103 causes the temperature detection unit 107 to collect temperature data. Subsequently, the flow proceeds to the step S402.

At the step S402, the processing similar to the step S202 in the first example embodiment is performed, and the flow proceeds to the step S403.

At the step S403, by using the acquired pressure data, temperature data, and the like, the control unit 203 calculates a fluid sound speed that is a sound speed of a wave propagating through fluid flowing in the pipe, and the flow proceeds to the step 404. For example, the sound speed of the fluid is acquired in accordance with a pressure indicated by the acquired pressure data and a temperature indicated by the acquired temperature data, by using a value (literature value) acquired in advance.

At the step S404, based on the formula (1), the control unit 203 calculates an inner diameter a of the pipe by using the acquired pressure data and temperature data, the calculated pipe sound speed, and the calculated fluid sound speed, and the flow proceeds to the step S405. Here, since a bulk modulus Bf of the fluid depends on a temperature, the control unit 203 calculates the bulk modulus Bf, based on the temperature data. Based on the calculated bulk modulus Bf, the control unit 203 calculates the inner diameter a of the pipe.

At the step S405, based on the formula (2), the control unit 203 calculates a pipe wall parameter of the pipe by using the calculated inner diameter a of the pipe, the calculated pipe sound speed, and the calculated fluid sound speed, and the flow proceeds to the step S406. Here, since a Young's modulus E of the pipe material depends on a temperature, the control unit 203 calculates the Young's modulus E of the pipe material, based on the temperature data. Based on the calculated Young's modulus E of the pipe material, the control unit 203 calculates the pipe wall parameter of the pipe.

At the step S406, the processing similar to the step S206 in the first example embodiment is performed, and the flow proceeds to the step S407.

At the step 5407, the processing similar to the step 5207 in the first example embodiment is performed, and the flow is ended.

### [Operations and Effect]

In the present invention, a configuration is made such that temperature data of a pipe material is acquired, in contrast to the first example embodiment. Thus, a fluid sound speed cf, a bulk modulus Bf of fluid, and a Young's modulus E of the pipe material can be calculated accurately. Therefore, calculation accuracy of an inner diameter a of a pipe and a pipe wall parameter of the pipe is improved, and more accurate diagnosis of a pipe condition can be implemented.

The present invention is described above as examples applied to the above-described typical example embodiments. However, the technical scope of the present invention is not limited to the scope described in each of the above example embodiments.

It is apparent for those skilled in the art that various modifications or improvements can be made on the example embodiments. In such a case, a new modified or improved example embodiment can be included in the technical scope of the present invention, as well. This is obvious from the matters described in the claims.

The present patent application claims priority based on Japanese patent application No. 2015-216244 filed on Nov. 4, 2015, the disclosure of which is incorporated herein in its entirety.

### REFERENCE SIGNS LIST

101 Vibration detection unit
102 Pressure detection unit
103, 203 Control unit
104, 202 Storage unit
105, 201 Communication unit
106 Vibration unit
107 Temperature detection unit
110, 210 CPU
140, 240 ROM
150, 250 RAM
204 Display unit
1000, 2000 Pipe condition detection system
1100a to 1100n, 2100a to 2100n Sensor unit
1200 Pipe condition detection device
1130, 1230 Memory

What is claimed is:

1. A pipe condition detection system comprising:
a sensor configured to detect vibration data and pressure data of a pipe or fluid in the pipe;
at least one processing component configured to:
calculating calculate a pipe wall parameter indicating rigidity of the pipe, based on the vibration data and the pressure data acquired by; the sensor; and
determine a deterioration condition of the pipe, based on the pipe wall parameter.

2. The pipe condition detection system according to claim 1, wherein the at least one processing component is further configured to:
calculate an inner diameter of the pipe, based on the vibration data and the pressure data acquired by the sensor, and
determine a deterioration condition of the pipe based on the inner diameter and the pipe wall parameter.

3. The pipe condition detection system according to claim 2, wherein the at least one processing component is further configured to determine a deterioration condition inside the pipe based on the inner diameter.

4. The pipe condition detection system according to claim 3, wherein the at least one processing component is further configured to determine, when a difference between an initial value of an inner diameter of the pipe and the inner diameter calculated is equal to or larger than a first predetermined value, that the condition inside the pipe is abnormal.

5. The pipe condition detection system according to claim 2, wherein the at least one processing component is further configured to determine, when a difference between an initial value of a pipe wall parameter of the pipe and the calculated pipe wall parameter is equal to or larger than a second predetermined value, that a deterioration condition outside the pipe is abnormal.

6. The pipe condition detection system according to claim 2, wherein the pipe wall parameter is one of a thickness of the pipe, a product of a thickness of the pipe and a Young's modulus of a pipe material, and a product of the thickness of the pipe and a density of the pipe material.

7. The pipe condition detection system according to claim 2, wherein the sensor further configured to detect temperature data, and
the at least one processing component is further configured to calculate the inner diameter of the pipe based on the vibration data, the pressure data, and the temperature data.

8. The pipe condition detection system according to claim 7, wherein the at least one processing component is further configured to calculate calculates the pipe wall parameter, based on the vibration data, the pressure data, the temperature data, and the inner diameter calculated.

9. The pipe condition detection system according to claim 2, wherein the at least one processing component is further configured to:
calculate a pipe sound speed based on the vibration data and the pressure data, the pipe sound speed being a sound speed of a wave propagating through the pipe; and
calculate a fluid sound speed based on the vibration data and the pressure data, the fluid sound speed being a sound speed of a wave propagating through fluid flowing in the pipe; and
calculate the inner diameter of the pipe based on the vibration data, the pressure data, the pipe sound speed, and the fluid sound speed.

10. The pipe condition detection system according to claim 9, wherein the at least one processing component is further configured to calculate the pipe wall parameter based on the vibration data, the pressure data, the pipe sound speed, the fluid sound speed, and the inner diameter calculated.

11. A pipe condition detection system comprising:
at least one processing component configured to:
calculate a pipe wall parameter based on vibration data and pressure data acquired by a sensor; and
determine a deterioration condition outside a pipe, based on the pipe wall parameter.

12. A pipe condition detection method comprising:
calculating a pipe wall parameter indicating rigidity of a pipe based on vibration data and pressure data acquired by a sensor; and
determining deterioration conditions inside and outside the pipe based on the pipe wall parameter.

13. A non-transitory computer-readable recording medium that stores a deterioration detection program causing a computer to execute:
a process of calculating a pipe wall parameter indicating rigidity of a pipe based on vibration data and pressure data acquired by a sensor; and
a process of determining conditions inside and outside the pipe based on the pipe wall parameter.
